(19) United States
(12) Patent Application Publication
(10) Pub. No.: US 2007/0278997 A1
(43) Pub. Date: Dec. 6, 2007

(54) BATTERY DEVICE CAPABLE OF CONVERTING MECHANICAL ENERGY INTO ELECTRICAL ENERGY

(76) Inventors: Yao-Tsung Chang, Taipei Hsien (TW); Shyh-Ching Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/464,207

(22) Filed: Aug. 14, 2006

(30) Foreign Application Priority Data
Jun. 5, 2006 (TW) 095119863

(51) Int. Cl. H01M 10/46

(52) U.S. Cl. 320/108; 320/137

(57) ABSTRACT

A battery device includes a housing including an anode and a cathode, an energy conversion module installed inside the housing for converting mechanical energy into electrical energy, and an energy storage module installed inside the housing for storing the electrical energy. The energy storage module includes an anode coupled to the anode on the housing, and a cathode coupled to the cathode on the housing. The battery device further includes a charge module installed inside the housing and coupled to the energy conversion module and the energy storage module. The charge module charges the energy storage module with the electrical energy generated by the energy conversion module. The charge module includes a rectifier for rectifying the electricity generated by the energy conversion module.

### BACKGROUND OF THE INVENTION

1. Field of the Invention

The present invention relates to a battery device, and more particularly, to a battery device capable of converting mechanical energy into electrical energy.

2. Description of the Prior Art

In general, a chemical battery can transfer chemical energy into electrical energy. The chemical battery includes advantages of portability, high energy density, no noise and waste gas, and so on, so the chemical battery is widely used in a notebook computer, and portable electronic apparatus, such as mobile phones and digital cameras. There are two kinds of the chemical battery, a non-rechargeable battery and a rechargeable battery. The non-rechargeable battery only can be used once, and chemical energy can not be supplied by charging the battery. The non-rechargeable batteries are a dry battery, a mercury battery, an alkaline battery, and so on. The rechargeable battery can be used repeatedly, and chemical energy can be supplied by charging the battery. The rechargeable batteries are a lead-acid battery, a NiMH battery, a lithium battery, an advanced lithium battery, and so on. When the non-rechargeable battery and the rechargeable battery run out of electricity, the non-rechargeable battery and the rechargeable battery can not provide electricity anymore at the moment, causing inconvenient to operate electronic apparatuses.

### SUMMARY OF THE INVENTION

It is therefore a primary objective of the claimed invention to provide a battery device capable of converting mechanical energy into electrical energy for solving the above-mentioned problem.

According to the claimed invention, a battery device includes a housing including an anode and cathode, an energy conversion module installed inside the housing for converting mechanical energy into electrical energy, and an energy storage module installed inside the housing for storing the electrical energy. The energy storage module includes the second anode coupled to the anode on the housing, and a cathode coupled to the cathode on the housing. The battery device further includes a charge module installed inside the housing and coupled to the energy conversion module and the energy storage module. The charge module charges the energy storage module with the electrical energy generated by the energy conversion module. The charge module includes a rectifier for rectifying the electricity generated by the energy conversion module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a battery device of the present invention.

FIG. 2 is a diagram of inner components of the battery device of the present invention.

FIG. 3 is a circuit diagram of the battery device of the present invention.

### DETAILED DESCRIPTION

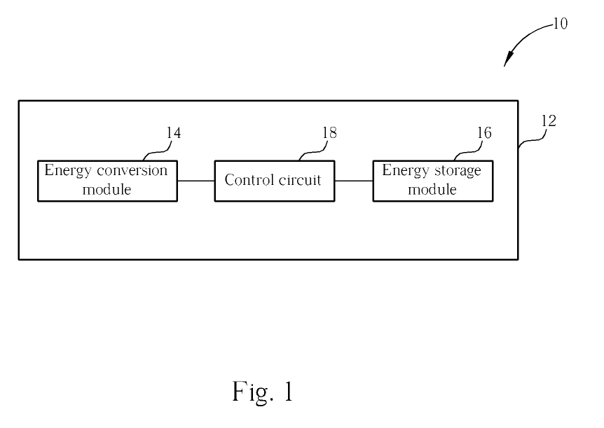

Please refer to FIG. 1. FIG. 1 is a functional block diagram of a battery device 10 of the present invention. The battery device 10 includes a housing 12, an energy conversion module 14 installed inside the housing 12 for converting mechanical energy into electrical energy, and an energy storage module 16 installed inside the housing 12 for storing the electrical energy. The energy storage module 16 can be a rechargeable battery or a capacitor. The battery device 10 further includes a charge module 18 installed inside the housing 12 and coupled to the energy conversion module 14 and the energy storage module 16. The charge module 18 charges the energy storage module 16 with the electrical energy generated by the energy conversion module 14.

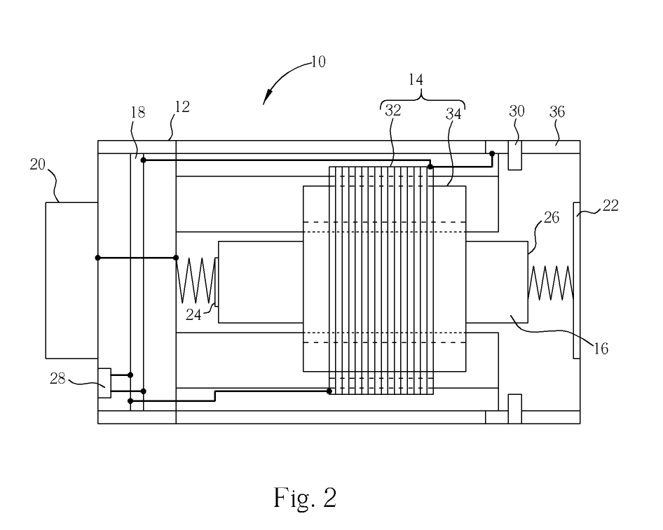

Please refer to FIG. 2. FIG. 2 is a diagram of inner components of the battery device 10 of the present invention. The housing 12 includes an anode 20 and a cathode 22. The energy storage module 16 includes an anode 24 coupled to the anode 20 on the housing 12, and a cathode 26 coupled to the cathode 22 on the housing 12. The charge module 18 can be a circuit laid out on a circuit board. The battery device 10 further includes a connection port 28 disposed on the housing 12 and coupled to the charge module 18 for receiving external electricity so as to charge the energy storage module 16. Furthermore, the battery device 10 further includes a detaching mechanism 30 installed on the housing 12. The detaching mechanism 30 can be combined with the cathode 22 on the housing 12. When a user opens the detaching mechanism 30, the user can draw out the energy storage module 16 inside the housing 12. If the energy storage module 16 is a standard rechargeable battery, such as an AA battery or an AAA battery, the energy storage module 16 can be charged and drew out for providing electricity for an electronic apparatus. The energy conversion module 14 includes a coil 32 installed inside the housing 12, and a magnet 34 installed inside the housing 12. The coil 32 and the magnet 34 can move relatively to each other. On the one hand the coil 32 can be a fixed coil installed inside the housing 12, and the magnet 34 can be a movable magnet installed inside the housing 12 in a movable manner relative to the coil 32. On the other hand the magnet 34 can be a fixed magnet installed inside the housing 12, and the coil 32 can be a movable coil 32 installed inside the housing 12 in a movable manner relative to the magnet 34. According to Lenz's Law, when there is a relative movement between the coil 32 and the magnet 34, the coil 32 generates an induced current so that the energy conversion module 14 converts kinetic energy of the magnet 34 or the coil 32 into the electrical energy. The induced current can be conducted to the charge module 18. The charge module 18 can rectify the electrical energy from the energy conversion module 14 and stores the rectified electrical energy in the energy storage module 16. For example, when the energy storage module 16 of the battery device 10 runs out of stored electricity, the user can shake the battery device manually so as to generate a relative movement between the coil 32 and the magnet 34. The energy conversion module 14 converts kinetic energy of the relative movement between the coil 32 and the magnet 34 into the electrical energy and stores the electrical energy in the energy storage module 16 so as to charge the battery device 10. In addition, an anode of the coil 32 is electrically connected to the anode 24 of the energy storage module 16 and the anode 20 on the housing 12, and a cathode of the coil 32 is electrically connected to the cathode 26 of the energy storage module 16 and the cathode 22 on the housing 12. The battery device 10 further includes a metal conductor 36 as a common ground connection of the cathode 26 of the coil 32, the charge module 18, the cathode 26 of the energy storage module 16, and the cathode 22 on the housing 12.

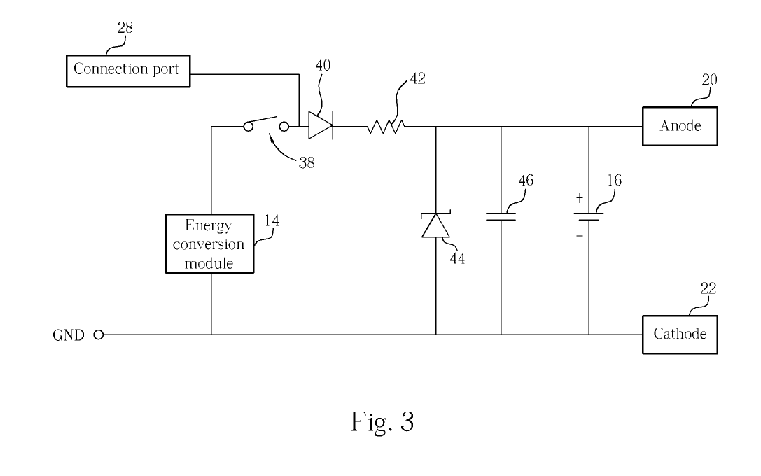

Please refer to FIG. 3. FIG. 3 is a circuit diagram of the battery device 10 of the present invention. The charge module 18 includes a switch 38 for controlling whether the energy storage module 16 can be charged, a rectifier 40 for rectifying the electricity generated by the energy conversion module 14 so as to prevent alternating current of electricity, a resistor 42 for limiting a charging current of the energy storage module 16 so as to prevent overcharging current, a zener diode 44 for fixing a charging voltage of the energy storage module 16, and a capacitor 46 for stabilizing the charging voltage of the energy storage module 16. The connection port 28 is coupled to the charge module 18 for receiving external electricity so as to charge the energy storage module 16. The switch 38 is at an open condition for terminating the energy conversion module 14 to charge the energy storage module 16 when the battery device 10 receives the external electricity via the connection port 28 so as to charge the energy storage module 16. On the contrary, the switch 38 is at a turn-on condition so that the energy conversion module 14 can charge the energy storage module 16 when the battery device 10 does not receive the external electricity via the connection port 28.

In contrast to the conventional battery device, the battery device according to the present invention can transform mechanical energy into electrical energy and store the electrical energy in the energy storage module. When the energy storage module of the battery device runs out of electricity, the user can shake the battery device manually so as to convert the mechanical energy into the electrical energy for an electronic apparatus. In addition, the energy storage module of the battery device can be charged by receiving the external electricity via the connection port. Furthermore, a general battery or a rechargeable battery can be disposed inside the battery device of the present invention for providing electricity to the electronic apparatus. If the charged energy storage module is a standard rechargeable battery, such as an AA battery or an AAA battery, the charged energy storage module can be drew out and utilized for other electronic apparatus as a battery at another size.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A battery device comprising:
a housing comprising an anode and a cathode;
an energy conversion module installed inside the housing for converting mechanical energy into electrical energy;
an energy storage module installed inside the housing for storing the electrical energy, the energy storage module comprising:
an anode coupled to the anode on the housing; and
a cathode coupled to the cathode on the housing; and
a charge module installed inside the housing and coupled to the energy conversion module and the energy storage module, the charge module charging the energy storage module with the electrical energy generated by the energy conversion module, the charge module comprising a rectifier for rectifying the electricity generated by the energy conversion module.

2. The battery device of claim 1 wherein the energy conversion module comprises:
a coil installed inside the housing; and
a magnet installed inside the housing in a movable manner relative to the coil;
wherein when the magnet moves relative to the coil, the coil generates an induced current so that the energy conversion module converts kinetic energy of the magnet into the electrical energy.

3. The battery device of claim 1 wherein the energy conversion module comprises:
a magnet installed inside the housing; and
a coil installed inside the housing in a movable manner relative to the magnet;
wherein when the coil moves relative to the magnet, the coil generates an induced current so that the energy conversion module converts kinetic energy of the coil into the electrical energy.

4. The battery device of claim 1 wherein the energy storage module is a rechargeable battery.

5. The battery device of claim 1 wherein the energy storage module is a capacitor.

6. The battery device of claim 1 wherein the charge module further comprises a resistor for limiting a charging current of the energy storage module.

7. The battery device of claim 1 wherein the charge module further comprises a zener diode for fixing a charging voltage of the energy storage module.

8. The battery device of claim 1 wherein the charge module further comprises a capacitor for stabilizing a charging voltage of the energy storage module.

9. The battery device of claim 1 wherein the charge module further comprises a switch for controlling whether the energy storage module can be charged.

10. The battery device of claim 1 further comprising a detaching mechanism installed on the housing for drawing out the energy storage module.

11. The battery device of claim 1 further comprising a connection port disposed on the housing and coupled to the charge module for receiving external electricity so as to charge the energy storage module.

12. A method for converting mechanical energy into electrical energy in a battery device, the method comprising:
(a) generating mechanical energy in the battery device;
(b) converting the mechanical energy into electrical energy in the battery device; (c) rectifying the electrical energy generated in step (b) in the battery device; and
(d) charging the battery device with the rectified electrical energy.

13. The method of claim 12 wherein step (a) comprises generating kinetic energy in the battery device by a relative motion of a coil and a magnet and step (b) comprises converting the kinetic energy of the coil or the magnet into the electrical energy in the battery device.

14. The method of claim 12 further comprising limiting a charging current of the battery device.

15. The method of claim 12 further comprising fixing a charging voltage of the battery device.

16. The method of claim 12 further comprising stabilizing a charging voltage of the battery device.

17. The method of claim 12 further comprising determining whether the battery device can be charged.

18. The method of claim 12 further comprising receiving external electricity so as to charge the battery device.
